(19) United States
(12) Patent Application Publication
(10) Pub. No.: US 2011/0043477 A1
(43) Pub. Date: Feb. 24, 2011

(54) Touch feedback panel, and touch screen device and electronic device inluding the same

(75) Inventors: Ho Joon Park, Seoul (KR); Yong Soo OH, Gyunggi-do (KR); Jong Young Lee, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/654,243

(22) Filed: Dec. 15, 2009

(30) Foreign Application Priority Data
Aug. 21, 2009 (KR) 10-2009-0077725

(51) Int. Cl. G06F 3/041; G06F 3/045

(52) U.S. Cl. 345/174; 345/173; 340/407.2

(57) ABSTRACT

A touch feedback panel includes a transparent electrode detecting a signal and a plurality of piezoelectric actuators disposed over the transparent electrode and partitioned into cells to generate a vibration only in a region where a signal is sensed.

### CROSS-REFERENCE TO RELATED APPLICATIONS

This application claims the priority of Korean Patent Application No. 10-2009-0077725 filed on Aug. 21, 2009, in the Korean Intellectual Property Office, the disclosure of which is incorporated herein by reference.

### BACKGROUND OF THE INVENTION

1. Field of the Invention

The present invention relates to a touch feedback panel, and a touch screen device and an electronic device including the same, and more particularly, to a touch feedback panel in which a plurality of actuators are disposed over the touch feedback panel and partitioned into cells to generate a vibration only in a region where a signal is sensed, and a touch screen device and an electronic device including the same.

2. Description of the Related Art

In general, touch feedback panels are designed to sense a touch state of a user to vibrate an entire device.

For example, a display device with a related art touch feedback panel includes a vibration element providing a vibration as a feedback when the touch feedback panel is touched. The vibration element is disposed at an edge of the display device.

At this time, since the vibration element disposed at the edge of the display device vibrates even though any position of the touch feedback panel is touched, the entire touch feedback panel vibrates in the same manner.

When the touch feedback panel is designed so that its entire panel vibrates, it is difficult to satisfy users who want to feel a delicate response. Therefore, there is a need for research on new touch feedback panel modules which are capable of providing greater satisfaction to users.

### SUMMARY OF THE INVENTION

An aspect of the present invention provides a touch feedback panel in which a plurality of actuators are disposed over the touch feedback panel and partitioned into cells to generate a vibration only in a region where a signal is sensed, and a touch screen device and an electronic device including the same.

According to an aspect of the present invention, there is provided a touch feedback panel including: a transparent electrode detecting a signal; and a plurality of piezoelectric actuators disposed over the transparent electrode and partitioned into cells to generate a vibration only in a region where a signal is sensed.

The actuators may be formed on an upper or lower surface of the transparent electrode.

The touch feedback panel may further include a protective cover formed at the outermost layer.

The piezoelectric actuators may be transparent piezoelectric bodies.

According to another aspect of the present invention, there is provided a touch screen device including: a touch feedback panel including a transparent electrode detecting a signal, and a plurality of piezoelectric actuators responding to a touch, disposed over the transparent electrode and partitioned into cells to generate a vibration only in a region where a signal is sensed; and a touch sensing unit attached to the touch feedback panel to sense the position of an input signal.

The touch sensing unit may be implemented as a resistive overlay type or a capacitive overlay type.

The transparent electrode may be formed of a conductive polymer or a conductive inorganic material.

The conductive polymer may be polythiophene (PEDOT), polyaniline, or a polymer thereof.

The conductive inorganic material may be tin oxide (ITO), antimony-doped tin oxide (ATO), aluminum-doped zinc oxide (AZO), or zinc oxide (ZnO).

The touch feedback panel and the touch sensing unit may be attached to each other with an optical clear adhesive.

The actuators may be formed of a zinc oxide material.

The touch screen device may further include a control unit causing the transparent piezoelectric actuators to vibrate in a specific pattern, depending on the input signal sensed by the touch sensing unit.

According to another aspect of the present invention, there is provided an electronic device including: a housing forming an exterior; a touch feedback panel provided in the housing and including a transparent electrode detecting a signal, and a plurality of piezoelectric actuators disposed over the transparent electrode and partitioned into cells to generate a vibration only in a region where a signal is sensed; and a touch sensing unit attached to the touch feedback panel to sense the position of an input signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a mobile communications terminal, which is an example of an electronic device according to an embodiment of the present invention, and a partial expanded perspective view of a touch screen device included in the mobile communication terminal;

FIG. 2 is a schematic cross-sectional view of a touch screen device according to an embodiment of the present invention;

FIG. 3 is a schematic cross-section view of a touch screen device according to another embodiment of the present invention;

FIG. 4 is a schematic cross-sectional view illustrating the combination of a touch feedback panel and a touch sensing unit in the touch screen device according to an embodiment of the present invention; and

FIG. 5 is a schematic cross-sectional view illustrating an operating state of actuators in the touch feedback panel according to the embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

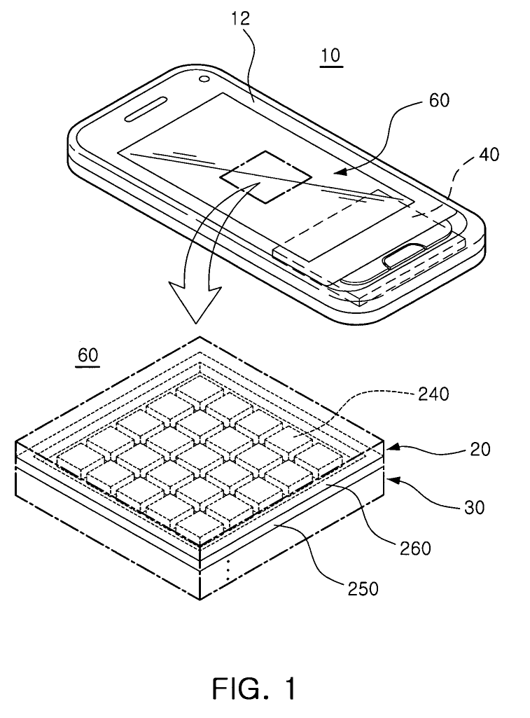

FIG. 1 is a schematic perspective view of a mobile communications terminal, which is an example of an electronic device according to an embodiment of the present invention, and a partial expanded perspective view of a touch screen device included in the mobile communication terminal.

The mobile communications terminal is illustrated as an example of the electronic device 10 according to the embodiment of the present invention.

The electronic device 10 includes a touch screen device 60 and a housing 12 for housing the touch screen device 60.

The housing 12 houses the touch screen device 60 and forms the exterior of the electronic device 10 with a front surface of the touch screen device 60.

When a signal is sensed by the touch screen device 60, only a transparent piezoelectric actuator 240 positioned in a region of the sensed signal responds among a plurality of transparent piezoelectric actuators 240. The transparent piezoelectric actuators 240 are formed in contact with a transparent electrode 250. Furthermore, the transparent piezoelectric actuators 240 may be formed on an upper or lower surface of the transparent electrode 250.

The plurality of transparent piezoelectric actuators 240 are provided over the transparent electrode 250 of the touch screen device 60 so as to be partitioned into cells.

The touch screen device 60 may include a protective cover 260 formed on an outer surface thereof to protect the transparent electrode 250 and the transparent piezoelectric actuators 240.

The cells are units which are obtained by partitioning the plurality of piezoelectric actuators and are separately driven.

Furthermore, the electronic device 10 may include a control unit 40 controlling response patterns of the piezoelectric actuators 240.

Hereinafter, the touch screen device 60 will be described in detail.

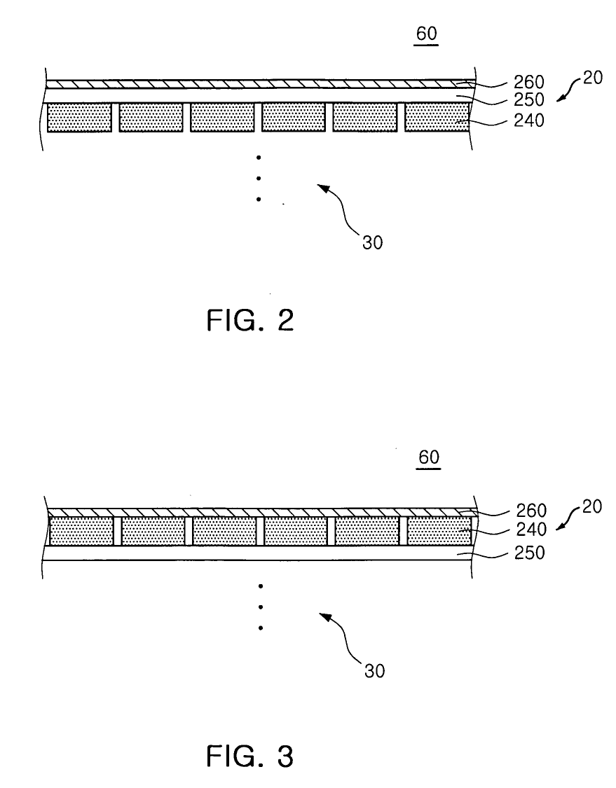

FIG. 2 is a schematic cross-sectional view of an example of the touch screen device according to the embodiment of the present invention. FIG. 3 is a schematic cross-section view of another example of the touch screen device according to the embodiment of the present invention.

Referring to FIGS. 2 and 3, the touch screen device 60 according to the embodiment of the present invention may include a touch feedback panel 20 and a touch sensing unit 30.

The touch feedback panel 20 may include the transparent electrode 250 sensing a signal and the plurality of actuators 240 disposed over the transparent electrode 250 and partitioned into cells. The actuators 240 generate a vibration only in a region of the transparent electrode 250 where a signal of is sensed.

The actuators 240 may be formed under the transparent electrode 250 as shown in FIG. 2 or on the transparent electrode 250 as shown in FIG. 3. In both cases, the protective cover 260 may be provided at the outermost layer of the touch feedback panel 20.

The actuators 240 may be partitioned into individual piezoelectric bodies and provided over the transparent electrode 250 as cell units which are separately driven.

The actuators 240 are formed of a transparent piezoelectric material in order for display of the electronic device, and zinc oxide is mainly used as the piezoelectric material.

Hereinafter, the touch screen device 60 including the touch feedback panel 20 will be described.

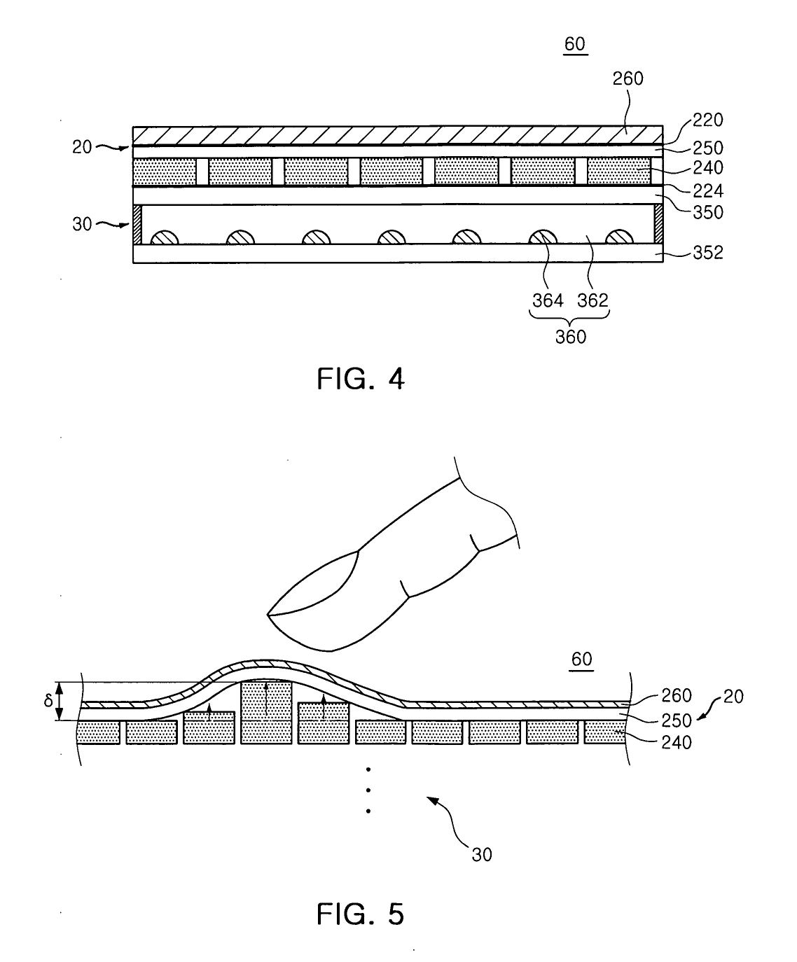

FIG. 4 is a schematic cross-sectional view of the touch screen device 60 according to the embodiment of the present invention, showing a state in which the touch feedback panel and a touch sensing unit are combined.

Referring to FIG. 4, the touch screen device 60 according to the embodiment of the present invention includes a touch feedback panel 20 and a touch sensing unit 30.

Since the touch feedback panel 20 is substantially the same as those shown in FIGS. 2 and 3, specific descriptions thereof will be omitted.

The touch sensing unit 30 may be implemented in a resistive overlay type like the embodiment of FIG. 4, but implemented in a capacitive overlay type.

The resistive overlay type touch sensing unit 30 includes transparent electrodes 350 and 352 disposed with a space 362 interposed therebetween. When the transparent electrodes 350 and 352 are contacted by being pressed, the touch sensing unit 30 senses a touch while recognizing the coordinates of the touch.

The transparent electrode 250 of the touch feedback panel 20 and the transparent electrodes 350 and 352 of the touch sensing unit 30 may be formed of a conductive polymer or conductive inorganic material.

The conductive polymer may be polythiophene (PEDOT) or polyaniline, and the conductive inorganic material may be indium tin oxide (ITO), antimony-doped tin oxide (ATO), aluminum-doped zinc oxide (AZO), or zinc oxide (ZnO).

The touch sensing unit 30 further includes dot spacers 364 disposed in the space 362, the dot spacers 364 serving to prevent the transparent electrodes 350 and 352 from being contacted with each other.

The transparent electrode 250 and the protective cover 260 of the touch feedback panel 20 may be attached to each other with an optical clear adhesive (OCA) 220, and the touch feedback panel 20 and the touch sensing unit 30 may be attached to each other through an OCA 224.

An input signal recognized by the touch sensing unit 30 is sent to the control unit to determine a vibration pattern of a transparent piezoelectric actuator 240.

FIG. 5 is a schematic cross-sectional view of the touch screen device 60 according to the embodiment of the present invention, showing a state in which the actuators of the touch feedback panel operate.

Referring to FIG. 5, when a finger is placed on the touch feedback panel 20, the transparent electrode 250 and the touch sensing unit 30 detect the touch to drive a transparent piezoelectric actuator 240.

At this time, only a transparent piezoelectric actuator 240 corresponding to an input position touched by the finger responds. Therefore, the entire touch feedback panel 20 does not vibrate, but only a portion corresponding to the input position touched by the finger responds.

The transparent piezoelectric actuator 240 corresponding to the input position touched by the finger is deformed to generate a displacement δ in a direction of the arrow as shown in FIG. 5.

Since only a portion of the touch feedback panel responds, a rapid response and vibration may be accomplished, making it possible to reduce device power consumption.

In accordance with the touch feedback panel, and the touch screen device and the electronic device including the same according to the embodiment of the present invention, a response occurs only in a region of the touch feedback panel where a signal is sensed. Therefore, a delicate response caused by a touch may be felt by a user.

Furthermore, a response pattern at a contact portion may be diversified so that a user can feel various responses. Therefore, the touch feedback panel may be utilized in various applications such as games, chatting, and web surfing.

While the present invention has been shown and described in connection with the exemplary embodiments, it will be apparent to those skilled in the art that modifications and variations can be made without departing from the spirit and scope of the invention as defined by the appended claims.

What is claimed is:

1. A touch feedback panel comprising:
a transparent electrode detecting a signal; and
a plurality of piezoelectric actuators disposed over the transparent electrode and partitioned into cells to generate a vibration only in a region where a signal is sensed.

2. The touch feedback panel of claim 1, wherein the actuators are formed on an upper or lower surface of the transparent electrode.

3. The touch feedback panel of claim 1, further comprising a protective cover formed at the outermost layer.

4. The touch feedback panel of claim 1, wherein the piezoelectric actuators are transparent piezoelectric bodies.

5. A touch screen device comprising:
a touch feedback panel comprising:
a transparent electrode detecting a signal; and
a plurality of piezoelectric actuators responding to a touch, disposed over the transparent electrode and partitioned into cells to generate a vibration only in a region where a signal is sensed; and
a touch sensing unit attached to the touch feedback panel to sense the position of an input signal.

6. The touch screen device of claim 5, wherein the touch sensing unit is implemented as a resistive overlay type or a capacitive overlay type.

7. The touch screen device of claim 5, wherein the transparent electrode is formed of a conductive polymer or a conductive inorganic material.

8. The touch screen device of claim 7, wherein the conductive polymer is polythiophene (PEDOT), polyaniline, or a polymer thereof.

9. The touch screen device of claim 7, wherein the conductive inorganic material is tin oxide (ITO), antimony-doped tin oxide (ATO), aluminum-doped zinc oxide (AZO), or zinc oxide (ZnO).

10. The touch screen device of claim 5, wherein the touch feedback panel and the touch sensing unit are attached to each other with an optical clear adhesive.

11. The touch screen device of claim 5, wherein the actuators are formed of a zinc oxide material.

12. The touch screen device of claim 5, further comprising:
a control unit causing the transparent piezoelectric actuators to vibrate in a specific pattern, depending on the input signal sensed by the touch sensing unit.

13. An electronic device comprising:
a housing forming an exterior;
a touch feedback panel provided in the housing and comprising a transparent electrode detecting a signal, and a plurality of piezoelectric actuators disposed over the transparent electrode and partitioned into cells to generate a vibration only in a region where a signal is sensed; and
a touch sensing unit attached to the touch feedback panel to sense the position of an input signal.
